(19) United States
(12) Patent Application Publication
(10) Pub. No.: US 2004/0065355 A1
(43) Pub. Date: Apr. 8, 2004

(54) Leak diverting device

(76) Inventor: Karen Lynn DeMartini, Austin, TX (US)

Correspondence Address: MEYERTONS, HOOD, KIVLIN, KOWERT & GOETZEL, P.C., P.O. BOX 398, AUSTIN, TX, 78767-0398, US

(21) Appl. No.: 10/678,868

(22) Filed: Oct. 3, 2003

Related U.S. Application Data
(63) Continuation-in-part of application No. 10/264,961, filed on Oct. 4, 2002.

(51) Int. Cl. B08B 9/20; B08B 3/00; B08B 3/04

(52) U.S. Cl. 134/34; 134/25.2; 134/104.2; 134/113

(57) ABSTRACT

In various embodiments, a leak diversion device may be coupled to a device, such as, but not limited to, a domestic or industrial device, for diverting a fluid that is released from the device. In some embodiments, a surface in the leak diversion device may be angled for diverting the diverted fluid to a predetermined location exterior to the device where a user may see the fluid. A hose may also be used to divert the fluid out of the leak diversion device. In some embodiments, the leak diversion device may have a permeable surface and/or enforced sides to provide level support for the device while allowing fluid released from the device to drop onto a slanted surface to be directed away from the device. In some embodiments, dye tabs may be used in the leak diversion device to add color to the fluid to make the fluid more visible.

### PRIORITY INFORMATION

This application is a continuation-in-part of U.S. patent application Ser. No. 10/264,961 filed Oct. 4, 2002.

### BACKGROUND OF THE INVENTION

1. Field of the Invention

The present invention relates generally to leak detection; and, more particularly, it relates to making leaks more visible.

2. Description of the Related Art

Leaks from devices, such as but not limited to, domestic, commercial, and industrial equipment and storage facilities may be hard to detect. Fluids from these devices may pool in a location not visible to users of the equipment. Damage from the leaked fluids may take many forms, such as, but not limited to, water damage or a buildup of hazardous vapors from a leaked hazardous chemical.

Fluids may be used in numerous ways by devices. Many devices using fluids provide a housing to prevent fluids from leaking outside the device during operation. Some devices may pool a large amount of fluid in sealed areas of the device such as a reservoir. A crack in a reservoir of the device may lead to large amounts of fluid unexpectedly leaving the device and spreading onto the floor of the building in which the device is installed. Also prone to failure are seals on the outside of the device housing where fluid may be pumped into or out of the device. A broken seal may lead to a periodic flow of fluid from the device when, with each use of the device, fluid may flow to an unexpected and hidden location where the fluid may cause severe damage. Furthermore, some devices may be designed to intentionally release fluids. For example, a device with a safety valve may release fluid if internal pressure becomes too high. If the user is not aware that fluid has leaked (e.g., if the fluid remains under the device), the user may not know that the device is having problems.

### SUMMARY

In various embodiments, a leak diversion device may be coupled to a device, such as, but not limited to, a domestic or industrial device, for diverting a fluid that is released from the device. In various embodiments, the device may be a dishwasher, a refrigerator, sink, storage container, ice-maker, or an air conditioning device. Other devices are also contemplated. In some embodiments, a surface in the leak diversion device may be angled for diverting the fluid to a predetermined location exterior to the device where a user may see the fluid. In some embodiments, dye tabs may be used in the leak diversion device to add color to the fluid to make the fluid more visible to the user.

In various embodiments, the leak diversion device may include an impermeable slanted surface that prevents a fluid from contacting a location beneath the leak diversion device. In some embodiments, the leak diversion device may also include a raised perimeter to prevent fluid from leaving the leak diversion device at unintended locations. In certain embodiments, whether the leak diversion device is circular or rectangular, the angling of the leak diversion device may be an inverted ridge that passes across the entire surface of the leak diversion device.

In various embodiments, leaks may be detected by relocating leaked fluids from devices using the leak diversion device. For example, in some embodiments, a leak diversion device may be provided beneath areas of a device that are prone to releasing fluid. In some embodiments, the leak diversion device may provide a slanted surface to relocate fluid that comes in contact with the slanted surface. In some embodiments, the leak diversion device may not have a slanted surface. For example, a hose may be provided on the leak diversion device to divert leaked fluids. In some embodiments, the leak diversion device may divert fluids that are released from the device and associated carrying tube of the device. In some embodiments, the released fluid may be diverted from the leak diversion device by channeling the fluid, with the aid of gravity, down the slanted surface of the leak diversion device to a predetermined location that is visible to a user (e.g., in front of the device).

In various embodiments, a hose may extend from the leak diversion device to provide a pathway for the fluid. In some embodiments, the hose may allow the diverted fluid to be directed away from both the leak diversion device and surface beneath the device.

In some embodiments, the leak diversion device may have a flat permeable surface to support the device while allowing any released fluids from the device to pass through holes in the permeable surface and onto a lower slanted surface. In some embodiments, the flat surface may be made of a permeable material without pre-formed holes to allow fluid to pass through. In some embodiments, fluid may flow down the slanted surface and to a more visible location (e.g., the front of the device). In some embodiments, the device may be supported from below by enforced sides of the leak diversion device. For example, the enforced sides may provide level support for the device while allowing released fluids to flow down the slanted surface lower than the upper edges of the enforced sides. In some embodiments, a slanted surface may be provided to the interior of a pallet underneath the device.

### BRIEF DESCRIPTION OF THE DRAWINGS

A better understanding of the present invention may be obtained when the following detailed description of several embodiments is considered in conjunction with the following drawings, in which:

FIG. 1 illustrates a front view of a device and leak diversion device, according to an embodiment of the invention.

FIG. 2 illustrates a side view of the device in FIG. 1 with a leak diversion device, according to an embodiment.

FIG. 3 illustrates a rectangular leak diversion device, according to an embodiment.

FIG. 4 illustrates a leak diversion device with a hose, according to an embodiment.

FIG. 5 illustrates a circular leak diversion device, according to an embodiment.

FIG. 6 illustrates a leak diversion device having a raised perimeter, according to an embodiment.

FIG. 7 illustrates a leak diversion device for diverting the fluid to a particular predetermined location, according to an embodiment.

FIGS. 8a, 8b, and 8c illustrate views of a leak diversion device with a permeable top surface for supporting a device, according to one embodiment.

FIGS. 9a, 9b, and 9c illustrate an embodiment of a leak diversion device without a top permeable surface for supporting a device.

FIGS. 10a, 10b, 10c, and 10d illustrate embodiments of a leak diversion device for use with a pallet.

FIG. 11 illustrates an embodiment of a leak diversion device for use with a pallet and forklift.

FIGS. 12a and 12b illustrate a leak diversion device with dye tabs, according to an embodiment.

FIG. 13 illustrates a leak diversion device underneath a sink, according to an embodiment.

FIG. 14 illustrates a leak diversion device used with an ice-maker, according to an embodiment.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF EMBODIMENTS

In various embodiments, fluids used in or associated with devices may be prone to leaking for various reasons, e.g., improper installation and defective connection seals. In addition, some fluids may be intentionally leaked (e.g., through a safety valve). In various embodiments, devices using fluids may include, but are not limited to, a dishwasher, a refrigerator, sink, storage container, pump, pipes, ice-maker, and an air conditioning device. Other devices are also contemplated.

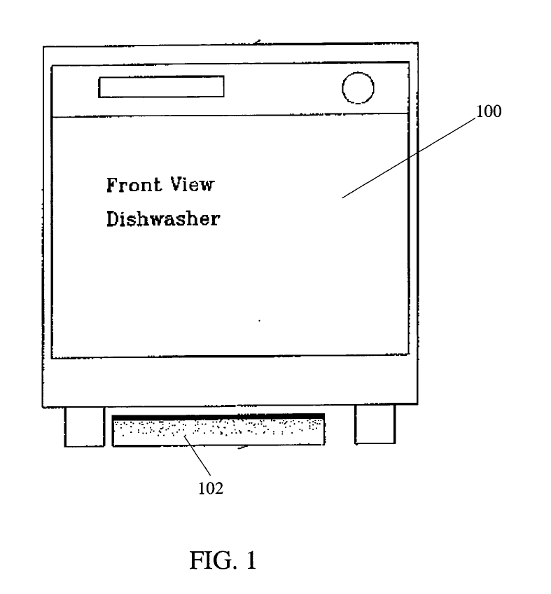

FIG. 1 illustrates a front view of an embodiment of a device 100 equipped with a leak diversion device 102. In some embodiments, the device 100 may include a leak diversion device 102 under the device 100. In some embodiments, the leak diversion device 102 may be a rectangular tray resting beneath the device 100. In some embodiments, the leak diversion device 102 may be coupled to the bottom of the device 100. For example, the leak diversion device 102 may be attached directly below portions of the device 100 that are prone to leaking. In some embodiments, the leak diversion device 102 may not be coupled to the device 100, but may be separate.

The device 100 may include hoses (not shown) and seals for the hoses where fluid is passed inside the device 100. A defective hose or a defective seal may allow fluid to exit the device 100 into an unexpected area concealed by the device. When fluid unexpectedly and repeatedly accumulates in certain areas, severe damage may occur. In various embodiments, the leak diversion device 102 may direct leaking fluid from hoses or seals of the device 100 to a location that is evident to users of the device. When an unexpected leak occurs in the device 100, the leak diversion device 102 may increase detectability of the leak to allow a user to take action to correct the defective part or replace a defective part before severe damage occurs.

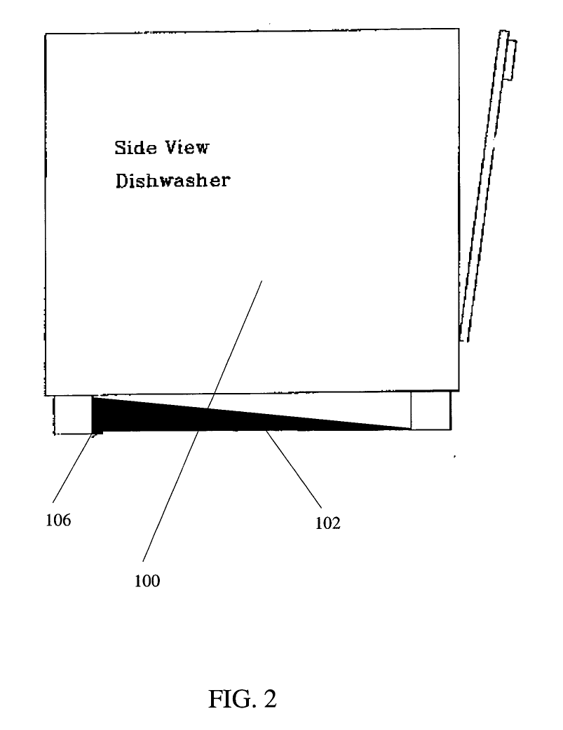

FIG. 2 illustrates a side view of the device 100 and leak diversion device, according to an embodiment. In some embodiments, the downward slope of the leak diversion device 102 may direct the fluid to the front of the device. In some embodiments, a support 106 may be used beneath the leak diversion device 102 to angle the leak diversion device 102 to disperse diverted fluid in a particular direction. In some embodiments, fluid released from the device 100 may fall into the leak diversion device 102 and run toward the front of the device 100 and onto the floor in front of the device 100 where it may become visible to users of the device. Users may then take corrective action before significant damage occurs.

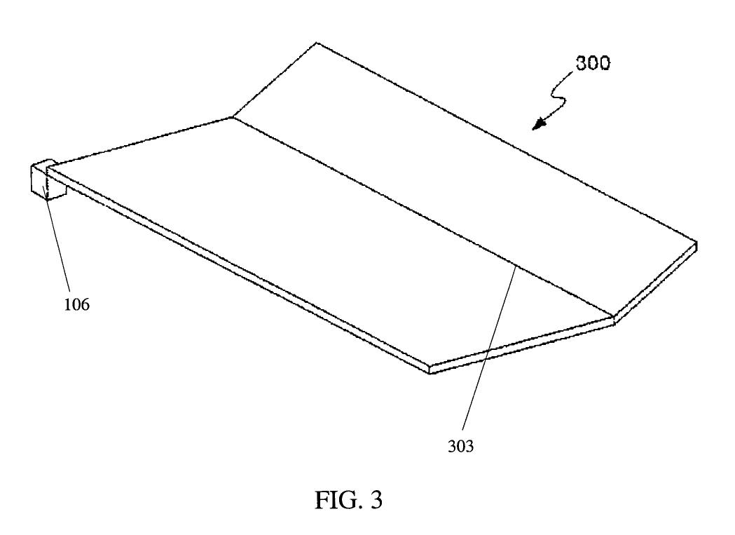

FIG. 3 illustrates an embodiment of a rectangular leak diversion device 300. In some embodiments, the leak diversion device 300 may include an angled sheet of impermeable material that is shaped such that fluid will flow off of the leak diversion device 300 to a particular location as fluids drop onto the leak diversion device 300. In some embodiments, an inverted ridge 303 may be used to concentrate a flow of released fluid down a channel of the leak diversion device. In some embodiments, concentrating the flow of released fluid down the inverted ridge 303 may make the fluid more noticeable to a user. In some embodiments, a support 106 may be provided to slant the leak diversion device 300 surface and allow fluid to flow to the front of the leak diversion device 300. Other surfaces are also contemplated to provide a downward angle to direct fluid.

FIG. 4 illustrates a leak diversion device 400, according to an embodiment. In some embodiments, the leak diversion device 400 may include a hose 402 that allows fluid to flow from the leak diversion device 400. In some embodiments, the leak diversion device 400 may be positioned to direct fluid from devices and, via a hose 402, route the fluid onto the floor in an area that is discoverable by a user of the device. For example, the leak diversion device 400 may be placed above a device, but below tubing that carries fluid that is meant to enter the top of the device. In some embodiments, the leak diversion device 400 may divert fluid that leaks from the tubing or its seals near the top of the device and route the leaking fluid through the tube to the floor. In some embodiments, the leak diversion device may be angled to direct fluids in the leak diversion device toward the hose. In some embodiments, instead of a hose, the leak diversion device may use an opening in a side of the leak diversion device to allow fluid out. The leak diversion device 400 and hose 402 may also capture fluid from a device that rests behind a wall and route the diverted fluid, with the hose 402, to a viewable location on the other side of the wall to a place more visible to a user.

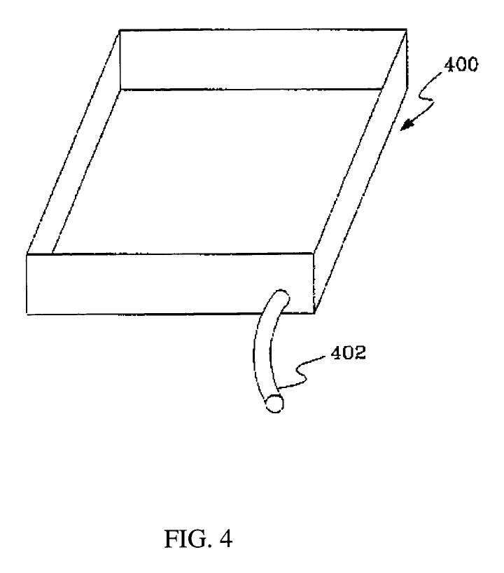

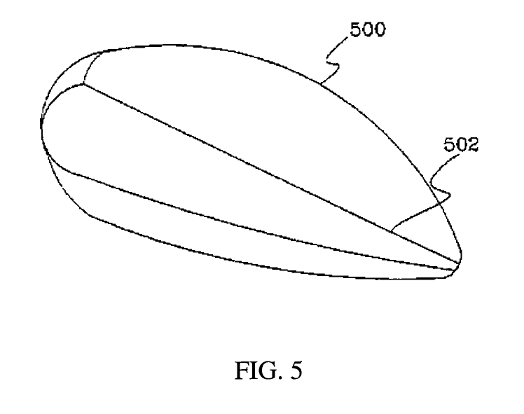

FIG. 5 illustrates a circular leak diversion device 500, according to an embodiment. In some embodiments, the circular leak diversion device 500 may include a ridge (also known as a channel or inverted ridge) 502 that channels fluid in a particular direction. In some embodiments, the circular leak diversion device 500 may take any shape that is required for the circular leak diversion device 500 to fit into a position at or near a device where the circular leak diversion device 500 directs fluid from the device and routes the fluid to a viewable area that is easily detected by a user of the device.

In various embodiments, the ridge 502 may be a straight diagonal channel across the leak diversion device 500. In some embodiments, to divert fluid to a particular location, the ridge 502 may be angled across the leak diversion device 500. For example, the ridge 502 may turn at approximately a 90-degree angle midway down the leak diversion device 500 so that fluid is diverted to a desired location.

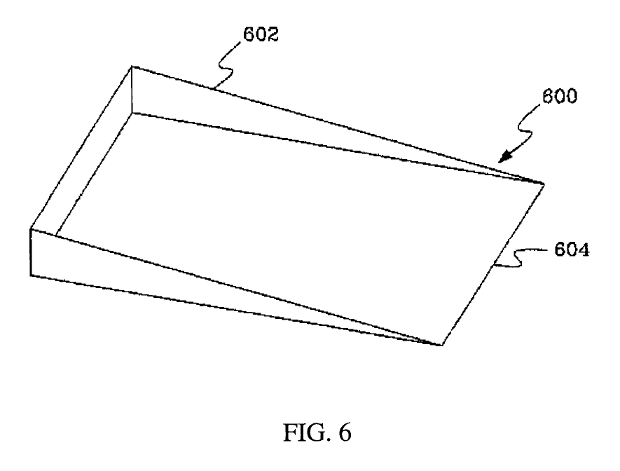

FIG. 6 illustrates a perspective view of a leak diversion device 600 having a raised perimeter 602. In some embodiments, the raised perimeter 602 may be a wall that prevents fluid from leaving the leak diversion device 600 unless the fluid has traveled to an unblocked end 604 of the device. In some embodiments, the raised perimeter 602 may cover three of the four sides of the leak diversion device 600 and if the leak diversion device 600 were circular or otherwise shaped, the raised perimeter 602 may cover portions of the leak diversion device 600 where fluid should not pass to leave the leak diversion device 600. In some embodiments, the surface of the leak diversion device 600 may be slanted. In some embodiments, the surface of the leak diversion device 600 may not be slanted, but may instead depend on a volume of fluid diverted in the leak diversion device 600 to push fluid out the front of the leak diversion device 600.

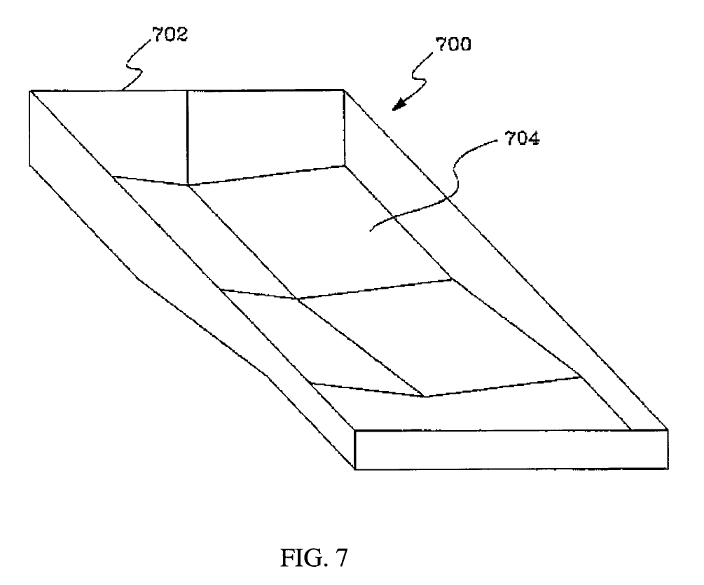

FIG. 7 illustrates an embodiment of a leak diversion device 700 to divert the fluid to a particular predetermined location, according to an embodiment. In some embodiments, the leak diversion device 700 may include a raised perimeter 702 bordering a multi-angled floor 704 of the leak diversion device 700. In some embodiments, the multi-angled floor 704 may divert the fluid over an edge of the leak diversion device 700. In some embodiments, the leak diversion device 700 and multi-angled floor 704 may be angled such that the fluid overflows only on the desired edge of the leak diversion device 700.

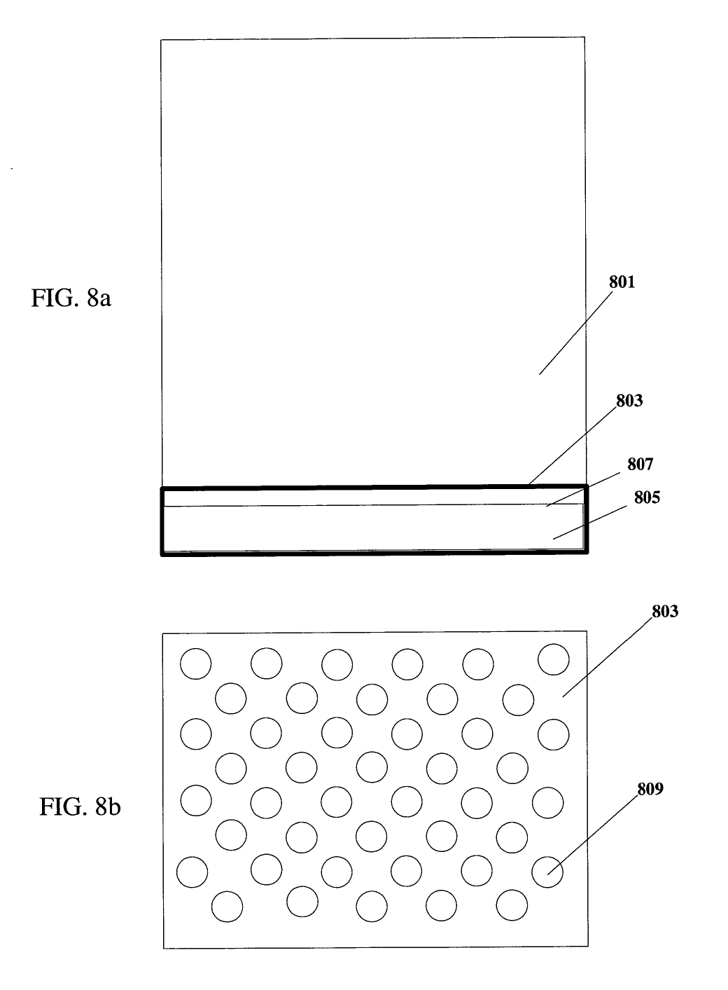

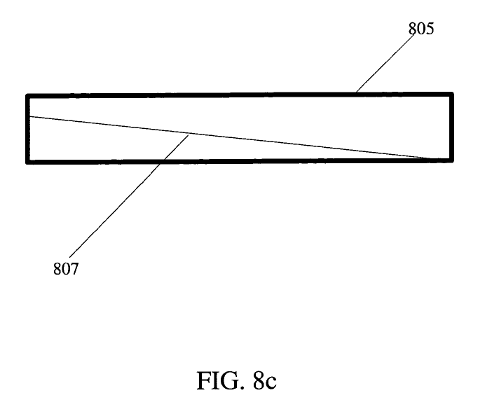

FIGS. 8a, 8b, and 8c illustrate a leak diversion device for supporting a device, according to one embodiment. In various embodiments, a device 801 may be a device such as, but not limited to, a refrigerator, sink, storage container, ice-maker, or an air conditioning device. Other devices are also contemplated. In various embodiments, leak diversion device 805 may be used with devices used in locations that do not have a drain. In some embodiments, leak diversion device 805 may have permeable surface 803 (seen in the top view of FIG. 8b) which may provide level support for the device 801 while allowing any released fluids from the device 805 to pass through holes 809 onto a slanted surface 807 (see also FIG. 8b) beneath the permeable surface 803. In some embodiments, the surface 803 may be made of a permeable material that allows fluid to pass through (e.g., without preformed holes). In some embodiments, fluid may flow down the slanted surface 807 (seen in side view of FIG. 8c) and to a more visible location at the front of the device 805. Other flat, permeable surfaces may also be used. In some embodiments, the permeable surface 803 may not be flat, but may be shaped to accommodate the device 805. In some embodiments, the device 805 may not be supported by the permeable surface 803. For example, the permeable surface 803 may be provided on a leak diversion device 805 that is separate from the device 805 (e.g., the permeable surface may make it easier to clean the leak diversion device 805).

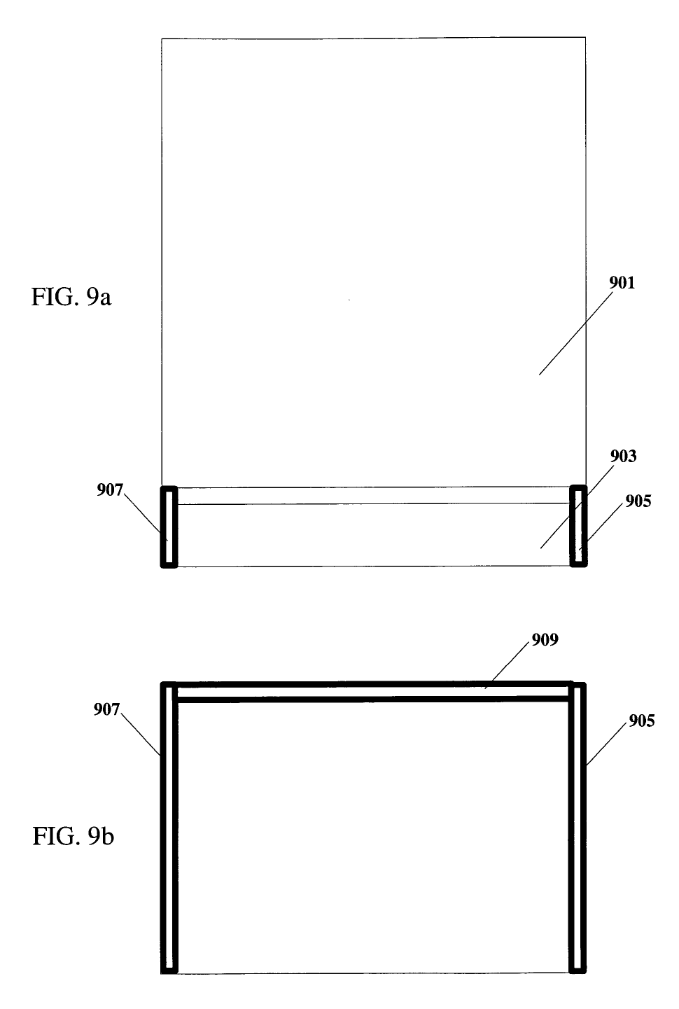

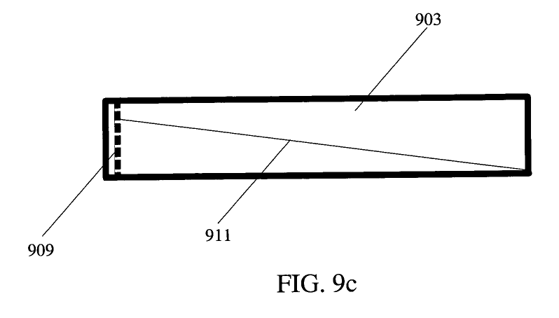

FIGS. 9a-9c illustrate an embodiment of a leak diversion device without a top permeable surface for a device. In some embodiments, the device 901 may be supported from below by enforced sides (e.g., 905, 907, and 909) of the leak diversion device 903 as seen in the top view of the leak diversion device in FIG. 9b. Other numbers of enforced sides are also contemplated. In some embodiments, sides 905, 907, and 909 may be enforced by using a material in the sides that is strong enough to support the weight of the device (e.g., a high strength plastic). In some embodiments, the sides may be enforced by supports (not shown). Other enforced sides are also contemplated. In some embodiments, the enforced sides 905, 907, and 909 may provide level support to the device 901 while allowing released fluids to flow down the slanted surface 911 (seen in side view shown in FIG. 9c).

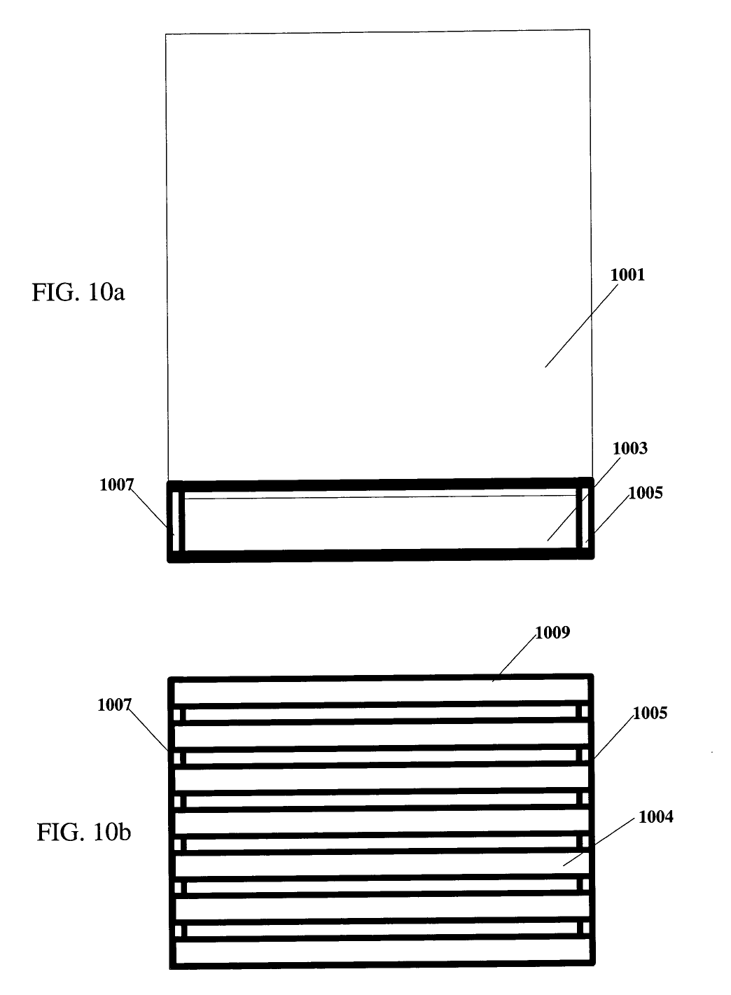

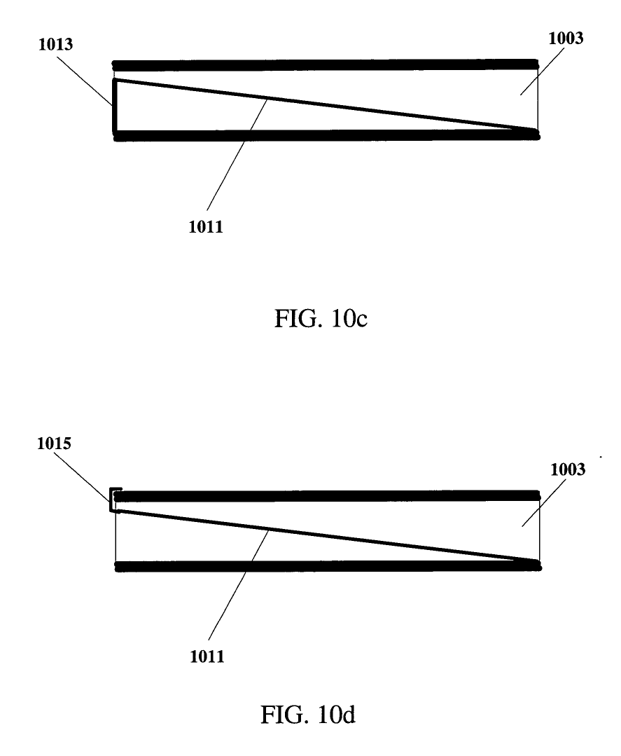

FIGS. 10a-10d illustrate embodiments of a leak diversion device using a pallet. In some embodiments, a pallet 1009 may be modified into a leak diversion device. In some embodiments, pallet 1009 may have support sides 1005 and 1007 supporting boards 1004 (as seen in the top view of FIG. 10b). In some embodiments, boards 1004 may provide level support to a device 1001. As seen in the side view of the embodiment shown in FIG. 10c, a slanted surface 1011 may fit in the interior of the pallet and be supported by support 1013. In one embodiment, the slanted surface 1011 may be supported by a hook 1015 attached to the top of the pallet 1009 (seen in the side view of the pallet in FIG. 10d). Other surfaces and coupling means are also contemplated for use with a pallet 1009.

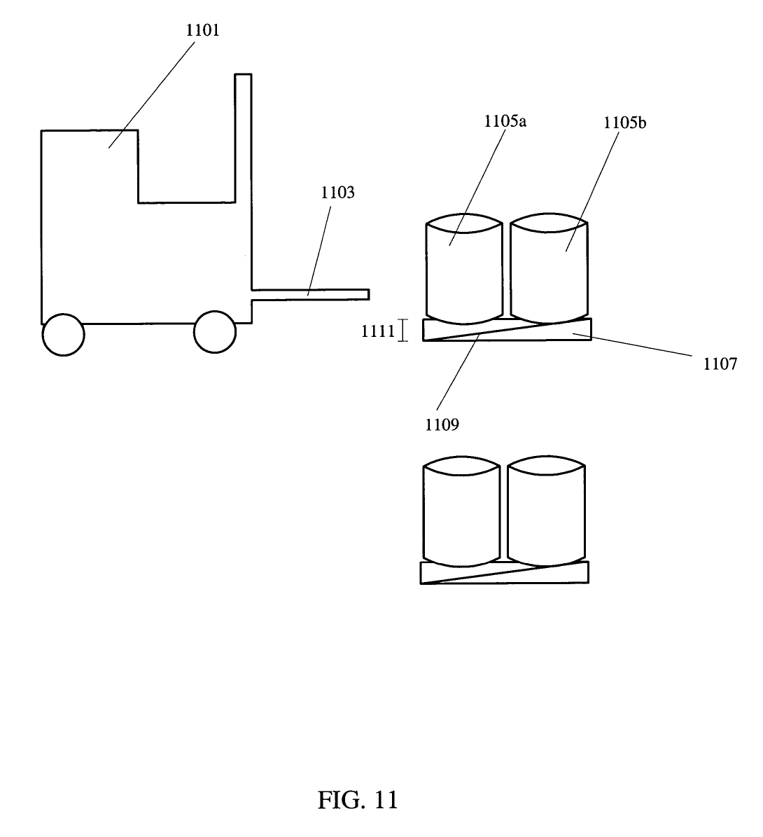

FIG. 11 illustrates an embodiment of a leak diversion device for use with a pallet and forklift. In some embodiments, a slanted surface 1109 may be fitted into a pallet 1107 that is configured to be moved by a forklift 1101. In some embodiments, pallet 1107 may be a standard pallet and slanted surface 1109 may be fitted into the pallet 1107 according to the embodiments discussed above with respect to FIGS. 10a-10d. In some embodiments, pallet 1107 may have a larger height 1111 to allow for additional clearance for the fork 1103 on the forklift 1101. The additional clearance may allow the pallet 1107 to be moved without damaging the slanted surface 1109. As seen in FIG. 11, the leak diversion device used with the pallet 1107 may be useful in detecting leaks from storage containers (e.g., barrels 1105). In some embodiments, barrels 1105 may store hazardous waste. If hazardous waste leaked from the barrels 1105, it may pool under the pallet 1107 where it may not be noticed. In some embodiments, putting a slanted surface 1109 into the pallet to use the pallet 1107 as a leak diversion device may allow leaked chemicals from the barrels 1105 to flow to a visible location. Corrective action may then be taken in time to prevent additional damage (e.g., if a hazardous chemical leak goes unnoticed, the leak may result in a harmful buildup of vapor that may explode or cause breathing difficulties).

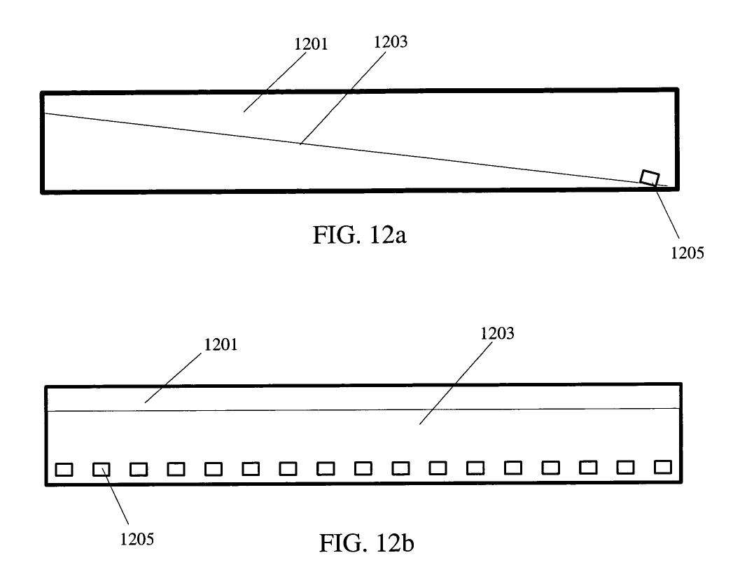

FIGS. 12a-12b illustrate an embodiment of the leak diversion device with dye tabs. In some embodiments, dye tabs 1205 may be coupled to the leak diversion device 1201 on slanted surface 1203. In some embodiments, the dye tabs 1205 may add color to a fluid flowing down the slanted surface to make the fluid more visible (as seen in the side view of FIG. 12a and front view of FIG. 12b). For example, the fluid may be clear and the dye tabs 1205 may add red dye to make the fluid appear red. In some embodiments, the dye tabs 1205 may be positioned in different locations in the leak diversion device 1201. In certain embodiments, the dye tabs 1205 may be loose in the leak diversion device 1201 (e.g., not coupled to the leak diversion device 1201). In various embodiments, the dye tabs 1205 may have other shapes and colors. For example, dye tabs 1205 may be a in a powder form on the slanted surface. In one embodiment, the powder may be coupled to the slanted surface using an adhesive. Other dye tab configurations are also contemplated.

In some embodiments, dye tabs 1205 may be different colors at different positions in the leak diversion device 1201 to indicate what direction the fluid came from. For example, the dye tabs 1205 on the right side of the leak diversion device 1201 may be red while the dye tabs on the left side of the leak diversion device may be green. In this embodiment, if the fluid coming from the leak diversion device is green, the user may know to check the left side of the device for a leak. In some embodiments, the dye tabs 1205 may react to the fluid and the fluid may be dyed (from the reaction) according to what type of fluid it is. For example, a dye tab may not change the color of water leaking through the leak diversion device 1201, but may react with bleach and dye the bleach red. A user viewing fluid from the leak diversion device 1201 may know that the fluid is bleach if it has been dyed red.

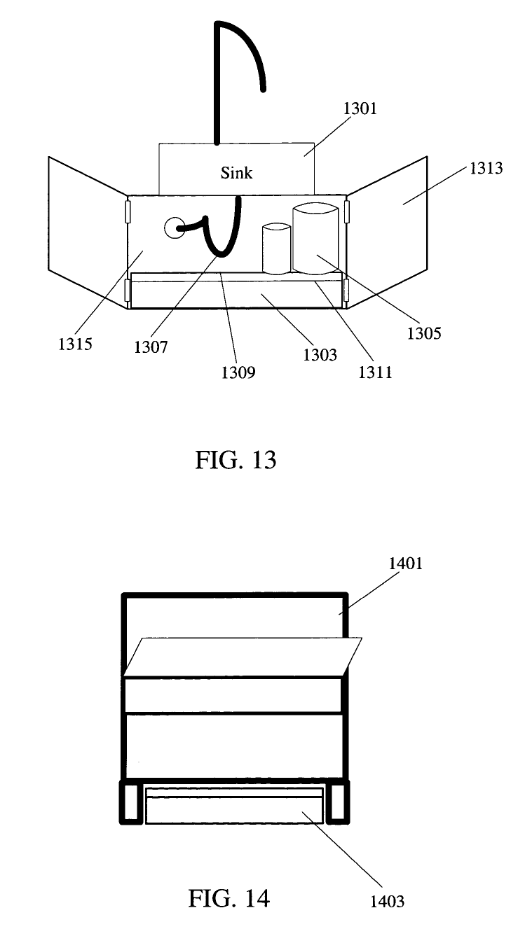

FIG. 13 shows an embodiment of a leak diversion device underneath a sink. In some embodiments, a leak diversion device 1303 may be used underneath a sink 1301. In some embodiments, the sink 1301 may be on top of a cabinet 1315. When doors 1313 are closed, a leak from pipe 1307 or from containers 1305 stored under the sink may go unnoticed. In some embodiments, a leak diversion device 1303 with a top permeable surface 1309 (also seen in FIGS. 8a-8c) may be used. The flat surface may allow containers 1305 to be stored on top of the leak diversion device 1303 while allowing any leaked fluids to fall through the top permeable surface 1309 and down the slanted surface 1311 to the front of the cabinet 1315 where it may be noticed. For example, the fluids may flow to the front of the cabinet 1315 and below the doors 1313 to the floor in front of the cabinet 1315

FIG. 14 shows an embodiment of a leak diversion device 1403 used with an ice-maker 1401. In some embodiments, a crack in the bottom of the ice-maker 1401 or a buildup of condensation from the ice-maker may cause damage to the floor beneath the ice-maker 1401 if unnoticed. The leak diversion device 1403 may direct the fluid to the floor in front of the ice-maker 1401 to alert a user of the ice-maker 1401 of the fluid. In addition, the leak diversion device 1403 may be used to direct the fluid to a location where it will not harm the floor beneath the ice-maker 1401. Other leaks and types of damage are also contemplated for the ice-maker 1401.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. An apparatus comprising:
a device; and
a leak diversion device comprising a slanted surface positioned to contact fluid released from the device, wherein the fluid on the slanted surface flows down the slanted surface to a predetermined location viewable by a user of the device.

2. The apparatus of claim 1, wherein the leak diversion device is coupled to the device.

3. The apparatus of claim 1, wherein at least part of the slanted surface rests on a support to angle the slanted surface.

4. The apparatus of claim 1, wherein the device is selected from a group consisting of a dishwasher, refrigerator, sink, ice-maker, pipe, pump, storage container, and air conditioner.

5. The apparatus of claim 1, wherein the device is at least partially supported by the leak diversion device.

6. The apparatus of claim 5, wherein the slanted surface is placed inside a pallet that is at least partially supporting the device.

7. The apparatus of claim 6, wherein the slanted surface is attached to at least part of the pallet.

8. The apparatus of claim 1, further comprising a surface coupled to the leak diversion device that has at least one hole to allow a fluid from the device to flow through at least one of the at least one hole onto the slanted surface.

9. The apparatus of claim 8, wherein the surface supports at least a part of the device.

10. The apparatus of claim 1, further comprising a permeable surface coupled to the leak diversion device to allow a fluid from the device to flow through the permeable surface onto the slanted surface.

11. The apparatus of claim 10, wherein the permeable surface supports at least a part of the device.

12. The apparatus of claim 1, wherein at least one side of the leak diversion device supports at least part of the weight of the device.

13. The apparatus of claim 1, further comprising a dye tab coupled to the slanted surface, wherein the dye tab changes a color of a fluid in contact with the dye.

14. The apparatus of claim 13, wherein the dye tab is positioned in the leak diversion device according to the color of the dye in the dye tab, wherein the fluid contacting the dye tab changes color and the color of the fluid indicates to a user an approximate location in the leak diversion device that the fluid flowed from respective to the location of the dye tab with the dye that colored the fluid.

15. The apparatus of claim 13, wherein the dye is in a powder form.

16. The apparatus of claim 13, wherein the dye tab reacts with a fluid to change the color of the fluid relative to the reaction.

17. The apparatus of claim 1, further comprising a hose coupled to the leak diversion device to divert fluid from the slanted surface to a location outside the leak diversion device.

18. A method, comprising:
providing a leak diversion device comprising a slanted surface underneath a device; and
diverting fluid in contact with the leak diversion device along the slanted surface to a location that is visible to a user of the device.

19. The method of claim 18, further comprising dyeing the fluid on the slanted surface using a dye tab to increase the visibility of the fluid.

20. The method of claim 18, wherein the leak diversion device comprises a substantially flat surface with at least one hole above the slanted surface, wherein the substantially flat surface supports at least a part of the device and at least one hole of the at least one hole allows a fluid from the device to fall through the substantially flat surface to contact the slanted surface beneath.

21. A leak diversion device, comprising:
an impermeable surface configured to catch a fluid released from a device; and
a slanted inverted ridge in the impermeable surface, wherein a fluid contacting the impermeable surface flows toward the inverted ridge and down the slanted surface to a predetermined location viewable by a user of the device that released the fluid.

22. The leak diversion device of claim 21, further comprising a substantially flat permeable surface attached above the slanted surface, wherein fluid released from the device flows past the permeable surface to the slanted surface.

23. The leak diversion device of claim 22, wherein the device is supported by the substantially flat permeable surface.

24. The leak diversion device of claim 21, further comprising at least two reinforced sides, wherein the device may be supported by the at least two reinforced sides above the slanted surface.

25. The leak diversion device of claim 21, further comprising at least one dye tab, wherein at least part of a fluid in contact with the dye tab changes color.
